(19) United States
(12) Patent Application Publication
(10) Pub. No.: US 2024/0286917 A1
(43) Pub. Date: Aug. 29, 2024

(54) Method for producing calcium carbonate solids from alkaline minerals

(71) Applicant: ETH Zürich, Zürich (CH)

(72) Inventors: Johannes Tiefenthaler, Zürich (CH); Marco Mazzotti, Zürich (CH); Mattheus Meijssen, Zürich (CH)

(73) Assignee: ETH Zürich, Zürich (CH)

(21) Appl. No.: 18/572,051

(22) PCT Filed: Jun. 29, 2022
(86) PCT No.: PCT/EP2022/067967

§ 371 Date: Dec. 19, 2023

(30) Foreign Application Priority Data
Jul. 1, 2021 (CH) CH070003/2021

(51) Int. Cl. C01F 11/18; C04B 14/28

(52) U.S. Cl. CPC C01F 11/181; C01F 11/185; C04B 14/28

(57) ABSTRACT

The present disclosure relates to a method for producing calcium carbonate solids from alkaline minerals including the following method steps: Supplying alkaline minerals and an extraction agent into a reactor tank. Stirring the alkaline minerals and the extraction agent in the reactor tank such that a first suspension is formed. Draining of the first suspension from the reactor tank and separating a liquid phase comprising calcium from the first suspension and transferring the liquid phase into a carbonation tank. Supplying a gas comprising CO2 into the carbonation tank, wherein the consumption of CO2 results in the precipitation of calcium carbonate solids thereby generating a second suspension and nucleating and growing of the calcium carbonate solids. Furthermore, a measure of the consumed CO2 is determined by at least one sensor.

### CROSS-REFERENCE TO RELATED APPLICATIONS

This application is a U.S. National Stage Application that claims the benefit of the filing date of International PCT Application No. PCT/EP2022/067967, filed on Jun. 29, 2022, that in turn claims priority to Swiss Application No. CH070003/2021, filed on Jul. 1, 2021, that are hereby incorporated by reference in their entirety.

### TECHNICAL FIELD

The present disclosure relates to a method for producing calcium carbonate solids from alkaline minerals, in particular by upcycling alkaline minerals.

### BACKGROUND

It is estimated that the process of manufacturing concrete (including the production of all components) emits annually about 2.5 Gt carbon dioxide equivalents. (Carbon dioxide is referred to as CO2 in the following.) 80-90% of the greenhouse gas (GHG) emissions of concrete can thereby be tracked back to the production of cement. In this process, a raw meal rich in limestone is heated with a fuel to 1500° C. to form Portland clinker. When the raw meal, which contains about 80% calcium carbonate (CaCO3), is heated to above 1000° C., it releases chemical bound CO2, accounting for ⅔ of the CO2 emissions associated with cement manufacturing. The remaining ⅓ of the emissions are due to the combustion of fuels to provide the required high temperature heat.

In Paris 2015, more than 180 countries (including EU, USA, China, India, Japan and Brazil) agreed on stopping global warming well below 2° C. This target translates into reducing the net—GHG emissions of all products over the whole life cycle. In the case of concrete, current emissions of roughly 228 kg CO2/m3 concrete have to be reduced to zero. At the same time, there is an increasing pressure on reducing the use of primary materials—which facilitates the use of secondary materials in the construction industry. Despite the fact, that from a circular economy perspective, these developments are wishful, the reuse of secondary materials in concrete comes currently at the cost of higher GHG emissions.

The main constitutes of concrete are sand, aggregate, cement and water. Sand and aggregate can originate from primary sources, or secondary sources (e.g. from demolition of buildings). Secondary resources are receiving more attention, since recycling of material has a number of environmental co-benefits. In the concrete sector, however, the reuse of demolished concrete as an aggregate for fresh concrete is bad for the climate. This is due to the fact that the cement mortar contained in concrete aggregates affects concrete properties such as compressive strength, durability, and strain-dependent properties, e.g., elasticity, shrinkage, and creep, such that the cement content from concrete made with secondary material is typically increased by 5-10% compared to concrete made with primary raw materials. Thus, a solution that upgrades secondary material to primary raw material quality can have a significant impact on the GHG balance and cost of concrete. The process of upgrading secondary material to primary material is generally referred to as upcycling.

### SUMMARY

The present disclosure relates to a method for producing calcium carbonate solids (CaCO3) from alkaline minerals, in particular by upcycling alkaline minerals. The disclosure thereby allows the transformation of alkaline minerals (representing secondary material or mineral waste) through an indirect mineral carbonation process into calcium carbonate solids. The calcium carbonate solids may be used as supplementary cementitious material (having a quality of primary material) for producing cement and/or concrete. Depending on the alkaline minerals, also sand can be produced. The sand may again serve as supplementary cementitious material. At the same time CO2 is stored during the carbonation process as solid calcium carbonate. This further improves the overall CO2 emission balance. The stored CO2 can e.g. originate from the atmosphere or a point source such as cement flue gas. By doing so, emissions of the past are mitigated by the generation of so called negative emissions.

According to the disclosure, the method producing calcium carbonate solids from alkaline minerals comprises the following method steps: a. Supplying the alkaline minerals into a reactor tank, b. supplying an extraction agent into the reactor tank, c. stirring the alkaline minerals and the extraction agent in the reactor tank such that a first suspension is formed, d. draining of the first suspension from the reactor tank and separating a liquid phase comprising calcium from the first suspension, e. transferring the liquid phase into a carbonation tank, f. supplying a gas comprising CO2 into the carbonation tank, wherein the consumption of CO2 results in the precipitation of calcium carbonate solids, thereby generating a second suspension, g. determining a measure of the consumed CO2 in the carbonation tank by at least one sensor, and h. nucleating and growing of the calcium carbonate solids. These methods steps are preferably performed in the described sequence, however, method step g. relating to the determination of the measure of the consumed CO2 can also be performed at other sequence positions, e.g. at the end of the process.

The extraction agent (supplied in method step b) is configured to extract calcium from the alkaline minerals (calcium is hereby understood in a broader sense including as all kinds of calcium ions). The extraction agent can be an aqueous salt solution, preferably an aqueous ammonium salt solution such as e.g. an aqueous ammonium nitrate solution or an aqueous ammonium chloride solution. Thus, the extraction agent usually comprises a suitable solvent (such as water) and a salt (such as an ammonium salt, in particular ammonium nitrate salt or ammonium chloride salt).

The alkaline minerals (supplied in method step a) may comprise calcium. Alternatively, or additionally, the alkaline minerals can comprise magnesium. If the process is executed with alkaline minerals comprising magnesium, the respective method steps can be executed accordingly (Therefore, in the following “calcium” can be replaced with “magnesium” and “calcium carbonate” with “magnesium carbonate”). The alkaline minerals may be in form of slags and/or ashes and/or demolition wastes. The slags can be generated during the production of iron and steel. The slag can be a basic oxygen furnace slag and/or an electric arc furnace slag and/or a ladle slag and/or a blast furnace slag and/or an argon oxygen decarburization slag. The demolition wastes can be among others cement kiln dust and/or cement bypass dust and/or waste cement and/or demolition concrete and/or concrete aggregate. The ashes can be solid waste incineration ashes (e.g. bottom ash, fly ash or air pollution control residue) or fuel combustion ashes (e.g. coal and lignite fly ash, oil shale ash, wood combustion fly ash, etc.). Also alkaline paper mill wastes can form the alkaline minerals.

The alkaline minerals are preferably pre-wetted, in particular with water, before supplied into the reactor tank. Pre-wetting the alkaline minerals fills pores of the alkaline minerals e.g. with water. This has the advantage, that the pores do not fill with extraction agent in the reactor tank, which results in lower loss of extraction agent during the overall process.

After supplying the alkaline minerals and the extraction agent in the reactor tank, the alkaline minerals and the extraction agent in the reactor tank are stirred such that the first suspension is formed (method step c). After the formation of the first suspension calcium (and/or the magnesium) is extracted from the first suspension. For a good extraction of calcium, the first suspension can remain in the reactor tank for an average extraction time of 5-60 minutes, in particular 15-25 minutes. Preferably, the first suspension is continuously stirred when in the reactor tank.

The separation of the liquid phase comprising calcium from the first suspension (method step d) can be performed by guiding the first suspension through a filter system. The filter system can comprise multiple filter stages. Thereby at least one (first) filter stage can serve for separating sand. Sand is thereby generally defined as having a particle size of less than 4 mm. As stated before, the sand can be used as a supplementary cementitious material. A further (second) filter stage can be arranged downstream for separating fine fractions. In context with this disclosure fine fractions are defined as having a particle size of less than 0.5 mm. The first filter stage can e.g. be a sieve or a cyclone filter and/or the second filter stage can be a filter press. After guiding the first suspension through the filter system the liquid phase comprising calcium is gained.

Afterwards the liquid phase is transferred into the carbonation tank (method step e). This can be done by guiding the first suspension through the filter system and further guiding the separated liquid phase from the filter system into the carbonation tank. Alternatively, the separated liquid phase can be collected and/or stored in an intermediate tank before transferring the liquid phase into the carbonation tank. The intermediate tank is in particular advantageous if the supply of the liquid phase in the carbonation tank is adjusted over time. This can e.g. be the case in the second control mode, as explained in more detail below.

The supply of the gas comprising CO2 in the carbonation tank (method step f) is preferably performed while generating fluidic vortices in the carbonation tank. This can e.g. be done means of at least one gas disperser. In one variation the gas can comprise 95% to 100%, in particular 99%-100% CO2. In another variation the gas can be a biogas comprising 30%-50% CO2. In another variation the gas can comprise 1-25% CO2. In the latter, the gas can be e.g. an exhaust gas flow, in particular the exhaust gas flow of a concrete plant. The (absolute) pressure in the carbonation tank may be between the environmental pressure and 10⁶ Pascal (Pa), in particular between 10⁵ Pa and 10⁶ Pa.

The consumption of CO2 in the carbonation tank results in the precipitation of calcium carbonate solids, thereby generating a second suspension (method step f). In the second suspension calcium carbonate can also be at least partially present as dissolved calcium carbonate (e.g. the calcium may be partially present as solid calcium carbonate and/or as calcium and carbon containing ions) before precipitating the calcium carbonate solids at a later point in time. The precipitation of calcium carbonate solids may thereby take place entirely in the carbonation tank. Alternatively, the precipitation of the calcium carbonate solids may take place partially in the carbonation tank and additionally in a growth tank, as explained in more detail hereinafter. Equivalently, the further nucleation and growth of the calcium carbonate solids may take place partially in the carbonation tank and additionally in a growth tank.

If a growth tank is used, the method further comprises the method step of draining the second suspension from the carbonation tank and transferring the second suspension into a growth tank. In this case, the nucleation and growth of calcium carbonate solids is further performed in the growth tank, resulting in an overall larger output of calcium carbonate solids in comparison if only a carbonation tank is used. The growth tank is at least 2 times, preferably 4 times, the size of the carbonation tank. The temperature of the growth tank can thereby be between 5-70 degrees Celsius, in particular 10 degrees Celsius-40 degrees Celsius. Meanwhile the residence time in the growth tank of the calcium carbonate solids may be between 10 minutes and 180 minutes, in particular between 30 minutes and 60 minutes. During the nucleation and growth of calcium carbonate solids, the growth of the calcium carbonate solids may be monitored. Thereby, a stirring speed and/or a residence time of the second suspension in the growth tank can be adjusted such that the calcium carbonate solids remain in a predefined size range. A preferred predefined size range is 500 nm (10⁻⁹ meter) to 125 micrometers (10⁻⁶ meter).

After nucleating and growing the calcium carbonate solids, the calcium carbonate solids can be separated from the second suspension. The separated calcium carbonate solids can then be washed and/or dried. The separation of the calcium carbonate solids from the second suspension can further result in a recyclable extraction agent. The recyclable extraction agent can be reused in method step a. as the extraction agent. The separated calcium carbonate solids may be used as a supplementary cementitious material for producing cement and/or concrete.

For the documentation of the captured and stored CO2 it is important to determine the measure of the consumed CO2 of the process (method step g). This can be done during the CO2 consumption or afterwards (e.g. after method step h). The measure of the consumed CO2 can be determined by performing a mass balance over a gas phase of the CO2 using at least one measured value of the at least one sensor. For a mass balance over the gas phase of CO2 a volumetric inflow and CO2 concentration of the gas comprising CO2 into the carbonation tank as well as a volumetric outflow and the CO2 concentration of remaining gas out of the carbonation tank must be known or measured. Since the CO2 concentration of the inflow is usually known, the measure of the consumed CO2 can easily be determined by at least three sensors: A first flow sensor measuring the volumetric inflow of the gas comprising CO2 into the carbonation tank, a second flow sensor measuring the volumetric outflow of the remaining gas out of the carbonation tank, and a concentration sensor measuring the CO2 concentration in the volumetric outflow of the remaining gas. If the CO2 concentration of the inflow is not known, a further concentration sensor measuring the CO2 concentration of the supplied gas comprising CO2 can be used. If the concentration of the CO2 is known and constant (e.g. always 99-100% CO2) also a less extensive mass balance can be performed, by using only the first flow sensor measuring the volumetric inflow of the gas comprising CO2 into the carbonation tank and the second flow sensor measuring the volumetric outflow of the remaining gas out of the carbonation tank. However, this determination method is advantageously for gas comprising between 99-100% CO2, since the measurement errors are comparably small.

In case the gas is known to comprise 99-100% CO2, the measure of the consumed CO2 can alternatively of additionally be determined by a pressure sensor measuring the pressure of the gas phase in the carbonation tank. The pressure may serve as a measure for the consumed CO2, since the pressure is directly affected, respectively reduced due to the CO2 consumption in the carbonation tank.

A very simple solution to determine the measure of the consumed CO2 in the carbonation tank is to use at least one sensor in form of a scale for measuring a weight of the dried calcium carbonate after the nucleation and growth of the calcium carbonate solids. The consumed CO2 in the carbonation tank in kilogram (kg) is hereby determined by multiplying the weight in kilogram (kg) by 44/100. This determination method is in particular good for verifying the consumed CO2 as e.g. needed for a CO2 certificate. However, a value of the consumed CO2, measured in such a way, cannot be used as a feedback signal for a control system for controlling the overall process.

Controlling the overall process is advantageous, since the alkaline minerals and the gas comprising CO2 can have an inhomogeneous composition. In particular, the composition of the alkaline minerals, and as such the extractable calcium may vary significantly. However, for further processing of the calcium carbonate solids it is important to obtain a reliable quality. A reliable quality is hereby understood as consistent parameters of the calcium carbonate solids, such as e.g. the particle size distribution and/or the crystal shape and/or the morphology. E.g. for further processing a particle size distribution of 500 nm to 125 micrometers is advantageous. The crystal shape may be e.g. cubic or spherical. To achieve such a reliable quality, the operating conditions of the overall process can be monitored and adjusted accordingly. Therefore, the method for producing calcium carbonate solids from alkaline minerals may be controlled by means of a control system. The control system is thereby preferably a closed-loop control system, also known as a feedback control system. A feedback value for the closed-loop control system can be the measure of the consumed CO2 in the carbonation tank and/or a measure of a calcium concentration of the first suspension, respectively the liquid phase of the first suspension.

In a first variation of the control system, the supply of the extraction agent and alkaline minerals into the reactor tank is adapted such that a target measure of a calcium concentration of the first suspension is achieved and/or such that a measure of the calcium concentration of the first suspension is held constant. This is especially advantageous, if the supplied CO2 composition and quantity are essentially always the same. To keep the measure of a calcium concentration essentially constant, the supply of the extraction agent and/or alkaline minerals can be adjusted over a certain time. Therefore, the supply of the extraction agent and/or alkaline minerals can be batchwise or continuously adjustable until the target measure of a calcium concentration of the first suspension is achieved. The measure of the calcium concentration can be determined equivalently from the liquid phase, e.g. in the intermediate tank. Generally, the change of a ph value (potentia Hydrogenii value) or the change of a conductivity value is already a good measure for the change of the calcium concentration. For a more accurate determination of the measure of the calcium concentration the ph value can be measured together with a temperature. Alternatively, also the conductivity value can be measured together with the temperature. Depending on the control, also the ph value, the conductivity value and the temperature can be measured together. As explained above, the measurements can be performed on the first suspension in the reactor tank or on the liquid phase before the supply of the liquid phase into the carbonation tank. The latter can e.g. be performed in the before mentioned intermediate tank. Alternatively, or in addition an ion selected electrode and/or a chromatograph can be used in order to determine therefrom the measure of the calcium concentration from the liquid phase and/or the first suspension.

In a second variation of the control system, a ratio of the measure of a calcium concentration and the measure of the consumed CO2 is held essentially constant. This control variation is especially advantageous, if the composition of the gas comprising CO2 varies overs time, as it is e.g. the case if an exhaust gas stream is used. The measure of a calcium concentration can thereby be measured from the liquid phase and/or the first suspension. The measure of a calcium concentration can be determined as explained in context of the first variation of the control system. Meanwhile the measure of the consumed CO2 can be determined as explained above during the process by e.g. performing a mass balance over a gas phase of the CO2 using at least one measured value of the at least one sensor. Good results have been found, if the ratio of the measure of a calcium concentration in mol/kg Water and the measure of the consumed CO2 in mol/kg Water is in the range of A=0.1-4, in particular between 0.5-2. Thereby, for applications of the calcium carbonate solids as cementitious material the ratio A is preferably in the range of A=0.5-1.1. In this case the calcium carbonate solids can be vaterite. This can be achieved if the temperature in the growth tank is held under 20 degrees Celsius. For the production of e.g. paper from the calcium carbonate solids the ratio is preferably A>1.1, resulting in calcite. Moreover, at temperatures exceeding 30 degrees Celsius, besides vaterite and calcite, also aragonite may be formed.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE DRAWINGS

The herein described disclosure will be more fully understood from the detailed description given herein below and the accompanying drawing which should not be considered limiting to the invention described in the appended claims. The drawing shows:

FIG. 1 An exemplary system for performing a method for producing calcium carbonate solids from alkaline minerals.

### DETAILED DESCRIPTION

Reference will now be made in detail to certain embodiments, examples of which are illustrated in the accompanying drawings, in which some, but not all features are shown. Indeed, embodiments disclosed herein may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

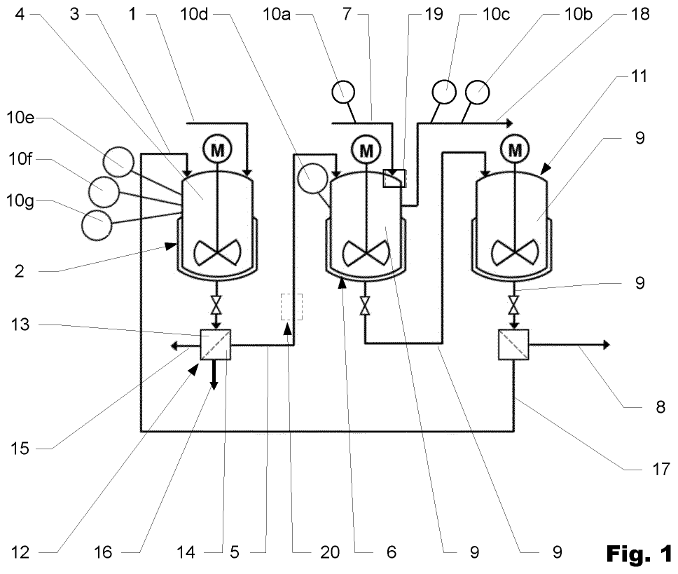

FIG. 1 shows a schematic view of a system for performing a method for producing calcium carbonate solids 8 from alkaline minerals 1. The system comprises a reactor tank 2, a carbonization tank 6 and a growth tank 11. Depending on the application, the growth tank 11 can be optional. The method starts in the reactor tank 2 by supplying alkaline minerals 1 and an extraction agent 3 into the reactor tank 2. The extraction agent 3 may be an aqueous ammonium salt solution. After or during the supply, the alkaline minerals 1 and the extraction agent 3 are stirred in the reactor tank 2 such that a first suspension 4 is formed. The first suspension 4 can remain for an average extraction time of 5-60 minutes, in particular 15-25 minutes, in the reactor tank 2 such that sufficient amount of calcium (and/or magnesium) is extracted. Afterwards, the first suspension 4 is drained from the reactor tank 2. In the shown variation, the first suspension 4 is then guided through a filter system 12. The filter system 12 can comprise two stages: a first stage 13 to separate sand 15 (e.g. by means of a sieve) and a second stage 14 to separate fine fractions 16 (e.g. by means of a filter press). After passing the filter system 12 a liquid phase 5 of the first suspension 4 remains, which comprises the extracted calcium. In a next step the liquid phase 5 is then transferred into the carbonation tank 6, where additionally a gas 7 comprising CO2 is supplied. The CO2 is then consumed by the calcium resulting in a second suspension 9 with precipitated calcium carbonate solids 8. For a better consumption the supply of the gas 7 comprising CO2 in the carbonation tank 6 can be performed while generating fluidic vortices in the carbonation tank 6, e.g. by means of at least one gas disperser 19. Furthermore, the second suspension 9 may also be stirred. After the precipitation, the further nucleation and growth of the calcium carbonate solids 8 is mainly outsourced in the growth tank 11. Therefore, the second suspension 9 is drained from the carbonation tank 6 and transferred and supplied into the growth tank 11, which can be at least two times, preferably four times, the size of the carbonation tank 6. In the growth tank 11 the further nucleating and growing of calcium carbonate solids 8 is performed. The growth of the calcium carbonate solids 8 can be monitored and a stirring and/or a residence time of the second suspension 9 in the growth tank 11 can be adjusted accordingly, such that the calcium carbonate solids 8 remain in a predefined size range. Finally, the calcium carbonate solids 8 can be separated from the second suspension 9. The remaining (liquid phase) of the second suspension 9 can be recycled as a recyclable extraction agent 17 into the reactor tank 2 for subsequent use. Meanwhile, the calcium carbonate solids 8 can be dried and/or washed. Furthermore, the dried calcium carbonate solids 8 can be weighted in order to determine and/or verify a measure of the consumed CO2 in the carbonation tank 6 by at least one sensor in form of a scale.

In order to better control and maximize the consumed CO2 in the carbonation tank 6, the measure of the consumed CO2 is preferably determined alongside the consumption of CO2 in the carbonation tank 6. This can be done by performing a mass balance over a gas phase of the CO2. Therefore, a first flow sensor 10a measuring the volumetric inflow of the gas 7 comprising CO2 into the carbonation tank 6, a second flow sensor 10b measuring a volumetric outflow of remaining gas 18 out of the carbonation tank 6, and a concentration sensor 10c measuring the CO2 concentration in the volumetric outflow of the remaining gas 18 can be used. If the inflow of gas 7 varies overtime, also a further concentration sensor measuring the measuring the CO2 concentration in the volumetric inflow of the gas 7 comprising CO2 can be used. If the gas 7 comprises 99-100% CO2, the measure of the consumed CO2 can further be determined by a pressure sensor 10d measuring the pressure in the carbonation tank 6.

The illustrated and described method for producing calcium carbonate solids from alkaline minerals can be controlled by a control system. Depending on the application the control system can e.g. keep a target measure of a calcium concentration of the first suspension 4 constant or even keep a ratio of the supplied calcium concentration of the liquid phase 5 and the measure of the consumed CO2 constant, as explained above. The calcium concentration can be determined by measuring a ph value and a temperature value, and/or a conductivity value and the temperature with appropriate sensors (ph sensor 10e, temperature sensor 10f and conductivity sensor 10e). Also the measurement of all three value are possible. The sensors can be placed on the reactor tank 2 or on an intermediate tank 20 or on a pipe between the reactor tank 2 and the carbonation tank 6.

The words used in the specification are words of description rather than limitation, and it is understood that various changes may be made without departing from the scope of the disclosure.

LIST OF DESIGNATIONS

| | |
|---|---|
| 1 | Alkaline minerals |
| 2 | Reactor tank |
| 3 | Extraction agent |
| 4 | First suspension |
| 5 | Liquid phase |
| 6 | Carbonation tank |
| 7 | Gas |
| 8 | Calcium carbonate solids |
| 9 | Second suspension |
| 10 | Sensor |
| 10a | First flow sensor |
| 10b | Second flow sensor |
| 10c | Concentration sensor |
| 10d | Pressure sensor |
| 10e | Ph sensor |
| 10f | Temperature sensor |
| 10g | Conductivity sensor |
| 11 | Growth tank |
| 12 | Filter system |
| 13 | First filter stage |
| 14 | Second filter stage |
| 15 | Sand |
| 16 | Fine fraction |
| 17 | Recyclable extraction agent |
| 18 | Remaining gas |
| 19 | Gas disperser |
| 20 | Intermediate tank |

1. A method for producing calcium carbonate solids from alkaline minerals, the method comprising the following method steps:
a. Supplying the alkaline minerals into a reactor tank;
b. Supplying an extraction agent, in particular an aqueous salt solution, into the reactor tank;
c. Stirring the alkaline minerals and the extraction agent in the reactor tank such that a first suspension is formed;
d. Draining of the first suspension from the reactor tank and separating a liquid phase comprising calcium from the first suspension;
e. Transferring the liquid phase into a carbonation tank;
f. Supplying a gas comprising CO2 into the carbonation tank, wherein the consumption of CO2 results in the precipitation of calcium carbonate solids thereby generating a second suspension;
g. Determining a measure of the consumed CO2 in the carbonation tank by at least one sensor; and
h. Nucleating and growing of the calcium carbonate solids.

2. The method according to claim 1, wherein the extraction agent is an aqueous ammonium salt solution, in particular an aqueous ammonium nitrate solution or an aqueous ammonium chloride solution.

3. The method according to claim 1, the method further comprising pre-wetting the alkaline minerals before supplying the alkaline minerals into the reactor tank.

4. The method according to claim 1, wherein the first suspension remains in the reactor tank for an average extraction time of 5-60 minutes, in particular 15-25 minutes.

5. The method according to claim 1, wherein the separation of the liquid phase from the first suspension is performed by guiding the first suspension through a filter system.

6. The method according to claim 5, wherein the alkaline minerals are in a form of concrete aggregate, and the filter system comprises a first filter stage separating sand for use as supplementary cementitious material.

7. The method according to claim 6, wherein the filter system comprises a second filter stage for separating fine fractions.

8. The method according to claim 1, wherein the supply of the gas comprising CO2 in the carbonation tank is performed while generating fluidic vortices in the carbonation tank.

9. The method according to claim 1, wherein the gas comprising CO2 is supplied in the carbonation tank by means of at least one gas disperser.

10. The method according to claim 1, the method further comprising
a. Draining the second suspension from the carbonation tank; and
b. Transferring the second suspension into a growth tank, wherein the nucleating and growing of calcium carbonate solids is performed in the growth tank.

11. The method according to claim 10, wherein the growth tank is at least 2 times the size of the carbonation tank.

12. The method according to claim 10, the method further comprising the continuous monitoring of the growth of the calcium carbonate solids and adjusting a stirring and/or a residence time of the second suspension in the growth tank such that the calcium carbonate solids remain in a predefined size range.

13. The method according to claim 1, the method further comprising separating the calcium carbonate solids from the second suspension.

14. The method according to claim 13, the method further comprising washing of the separated calcium carbonate solids.

15. The method according to claim 14, the method further comprising drying of the calcium carbonate solids and weighting of the dried calcium carbonate solids.

16. The method according to claim 13, wherein the separation of the calcium carbonate solids from the second suspension further results in a recyclable extraction agent.

17. The method according to claim 1, the method further comprising using the calcium carbonate solids as supplementary cementitious material for producing cement and/or concrete.

18. The method according to claim 1, the method further comprising adjusting the supply of the extraction agent and alkaline minerals into the reactor tank to achieve a target measure of a calcium concentration of the first suspension.

19. The method according to claim 1, the method further comprising keeping an essentially constant ratio of A to B, wherein
a. A is a measure of a calcium concentration of the liquid phase or the first suspension, and
b. B is the measure of the consumed CO2.

20. The method according to claim 18, the method further comprising determining the measure of the calcium concentration of the liquid phase or the first suspension by measuring
i. a ph value and a temperature, and/or
ii. a conductivity value and the temperature.

21. The method according to claim 18, the method further comprising performing an ion selective electrode or chromatography of the liquid phase and/or the first suspension and determining therefrom the measure of the calcium concentration.

22. The method according to claim 1, wherein the measure of the consumed CO2 is determined by performing a mass balance over a gas phase of the CO2 using at least one measured value of the at least one sensor.

23. The method according to claim 1, wherein the measure of the consumed CO2 is determined by at least three sensors, the at least three sensors being
a. a first flow sensor measuring a volumetric inflow of the supplied gas comprising CO2 into the carbonation tank,
b. a second flow sensor measuring a volumetric outflow of remaining gas out of the carbonation tank, and
c. a concentration sensor measuring the CO2 concentration in the volumetric outflow of the remaining gas.

24. The method according to claim 1, wherein the gas comprises 99-100% CO2 and the measure of the consumed CO2 is determined by at least one sensor in a form of a pressure sensor measuring the pressure in the carbonation tank.
